(19) United States
(12) Patent Application Publication
(10) Pub. No.: US 2005/0156474 A1
(43) Pub. Date: Jul. 21, 2005

(54) Rotating machine

(75) Inventor: Kenji Endo, Yokohama (JP)

Correspondence Address: FOLEY AND LARDNER;SUITE 500, 3000 K STREET NW, WASHINGTON, DC, 20007, US

(73) Assignee: JATCO Ltd

(21) Appl. No.: 11/030,958

(22) Filed: Jan. 10, 2005

(30) Foreign Application Priority Data
Jan. 20, 2004 (JP) 2004-012268

(51) Int. Cl. H02K 7/09; H02K 21/12

(52) U.S. Cl. 310/156.53

(57) ABSTRACT

A rotating machine is comprised of a rotor having permanent magnets and a stator disposed around the rotor. At least a surface of the permanent magnet, which faces the stator, is covered with a magnetic material whose thickness is determined on the basis of an electrical conductivity of the magnetic material, a magnetic permeability of the magnetic material and a frequency of a high-frequency magnetic flux act from the stator on the rotor.

### BACKGROUND OF THE INVENTION

The present invention relates to a rotating machine, and more particularly to a rotating machine comprising a rotor including a permanent magnet.

Japanese Published Patent Application No. 2000-324738 discloses a rotating machine which comprises a rotor including a rare-earth-alloy permanent magnet made by a sinter alloy of rare earth metal, such as Sm—Co alloy or Nd—Fe—B alloy. Further, Japanese Published Patent Application No. 6-140217 discloses a technique of coating a rare-earth-alloy permanent magnet with metal plating whose thickness is greater than 3 μm and smaller than or equal to 20 μm, for the purpose of preventing a corrosion of the permanent magnet.

### SUMMARY OF THE INVENTION

However, the metal plating formed on the permanent magnet is for preventing the corrosion of the permanent magnet, and never gains the advantage of preventing a so-called induction heating of the permanent magnet by such metal plating having the thickness ranging from 3 to 20 μm.

Herein, there is simply explained the induction heating. A permanent magnet synchronous machine is generally arranged to rotate a rotor according to a rotating magnetic field generated by an armature coil. The rotor receives two magnetic flux one of which is a basic magnetic flux of applying a rotational force to the rotor and the other of which is a high-frequency magnetic flux generated according to the structure of the armature coil such as a concentrated winding.

The basic magnetic flux is static with respect to a permanent magnet rotating in synchronism with the rotating magnetic field and exhibits the direct-current like behavior. Therefore, the basic magnetic flux does not cause induction heating. On the other hand, the high-frequency magnetic flux tends to penetrate into a permanent magnet due to a high-frequency component thereof. Specifically, in case of a rare-earth permanent magnet made by an electro-conductive sintered body, it is difficult to avoid the generation of Joule heat according to the eddy current reaction function against the high-frequency magnetic field. That is, induction heat is unavoidably generated in the rare-earth permanent magnet so as to lower the output of the rotating machine including the permanent magnet in a reversible demagnetization range according to temperature and to lose the magnetic properties in an irreversible demagnetization range according to temperature.

It is therefore an object of the present invention to provide an improved rotating machine which solves the problems about the induction heating, in addition to the prevention of the corrosion into the rare-earth permanent magnet.

The inventor of the present invention intensively researched a loss generation mechanism of a rare-earth magnet coated with metal plating whose thickness is greater than 3 μm and smaller than or equal to 20 μm, and found that it became possible to solve the problems about the induction heating of the rare-earth permanent magnet by adjusting the thickness of metal plating on the surface of the permanent magnet so as to prevent the permeation of the high-frequency magnetic flux into the magnet while preventing the corrosion of the magnet.

An aspect of the present invention resides in a rotating machine which comprises a rotor in which a permanent magnet is embedded and a stator disposed around the rotor, wherein at least a surface of the permanent magnet, which faces the stator, is covered with a magnetic material, and a thickness of the magnetic material is determined on the basis of an electrical conductivity of the magnetic material, a magnetic permeability of the magnetic material and a frequency of a high-frequency magnetic flux acting from the stator on the rotor.

Another aspect of the present invention resides in a permanent magnet synchronous machine which comprises a stator, a rotor and a metal layer. The stator comprises a cylindrical yoke and teeth around which stator windings are wound, respectively. The rotor is disposed coaxially with the stator in a center space defined by the stator to be coaxial with the stator and rotatable with respect to the stator. The rotor comprises a plurality of permanent magnets which are disposed around a center axis of the rotor. The metal layer covers a surface of each permanent magnet which faces the stator. The metal layer being made of a magnetic material. A thickness of the magnetic material being determined on the basis of an electrical conductivity of the magnetic material, a magnetic permeability of the magnetic material and a frequency of a high-frequency magnetic flux acting on the rotor.

The other objects and features of this invention will become understood from the following description with reference to the accompanying drawings.

### BRIEF DESCRIPTION OF THE DRAWINGS

FIG. 1 is a cross sectional view showing a permanent magnet synchronous machine (rotating machine) according to an embodiment of the present invention.

FIG. 2 is an exploded perspective view showing a rotor of the permanent magnet synchronous machine.

FIGS. 3A and 3B are cross sectional views of a rare earth permanent magnet of the rotor.

FIG. 4 is a graph employed for explaining a critical meaning as to a lower limit thickness of a plated layer on the rare earth permanent magnet.

FIG. 5 is a graph showing a relationship between an appropriate thickness of the plated layer and a frequency of high-frequency magnetic flux.

### DETAILED DESCRIPTION OF THE INVENTION

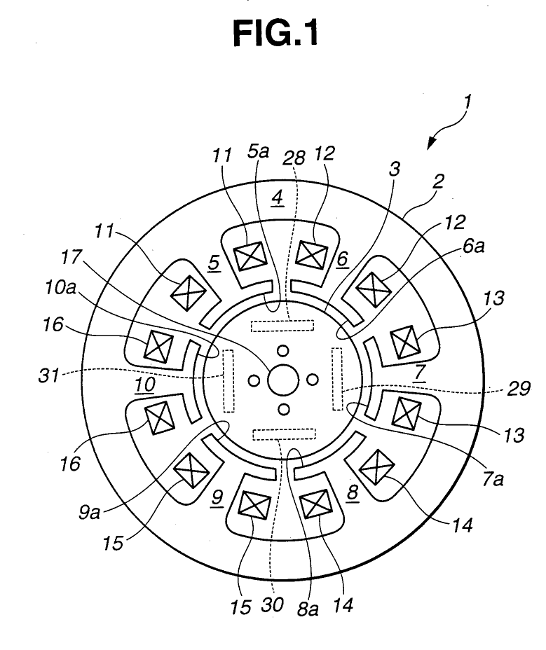

Referring to FIGS. 1 through 5, there is discussed an embodiment of a permanent magnet synchronous machine 1 according to the present invention.

As shown in FIG. 1, permanent magnet synchronous machine (rotating machine) 1 comprises a stator 2 and a rotor 3. Stator 2 comprises a cylindrical yoke 4 and teeth 5 through 10 which radially and inwardly project from an inner surface of cylindrical yoke 4 at equal intervals. Cylindrical yoke 4 and teeth 5 through 10 are integrally formed from a magnetic material such as silicon steel sheets. Stator windings 11 through 16 are wound around teeth 5 through 10, respectively.

Rotor 3 is a cylindrical rotating member which has a shaft fixed at a center of rotor 3. Rotor 3 is disposed in a space defined by stator 2 such that rotor 3 is capable of rotating in stator 2 while maintaining a predetermined distance with respect to innermost ends 5a through 10a of teeth 5 through 10.

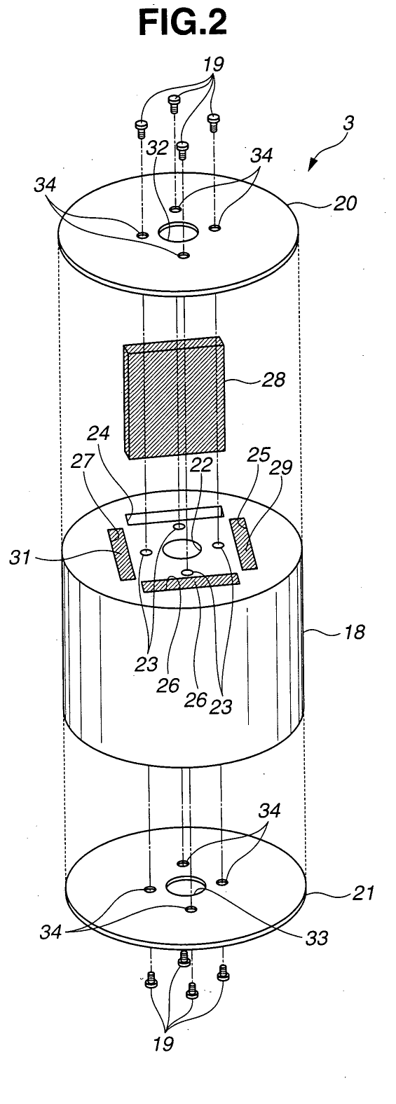

As shown in FIG. 2, rotor 3 comprises a cylindrical main body 18 which is constructed by laminating magnetic material sheets such as silicon steel sheets and two discs 20 and 21 fixed to both end portions of main body 18 by means of bolts 19. A fixing hole 22 for shaft 17 is formed on the center of main body 18, and fixing holes 23 for bolts 19 are formed around fixing hole 22. Further, four magnet embedding holes 24 through 27 are formed around fixing holes 22 and 23 along the axial direction of rotor 3. Identically-shaped rare-earth permanent magnets 28 through 31, which are made of sintered rare-earth metal such Sm—Co type permanent magnet alloy or Nd—Fe—B type permanent magnet alloy, are embedded in four magnet embedding holes 24 through 27, respectively.

Each of discs 20 and 21 made of metal sheet has a through hole 32, 33 for shaft 17 and a through holes 34 for bolts 19. Discs 20 and 21 function so as to prevent rare-earth permanent magnets 28 through 21 from being detached from magnet embedding holes 24 through 27. If rare-earth permanent magnets 28 through 21 are fixed in magnet embedding holes 24 through 27 using adhesive or the like, discs 20 and 21 may be omitted.

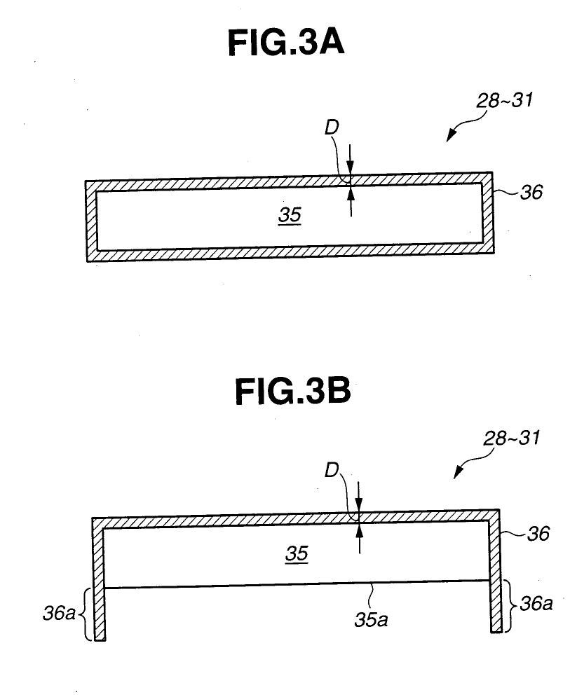

FIG. 3A shows a cross sectional view of one of rare-earth permanent magnets 28 through 31. Each of rare-earth permanent magnets 28 through 31 comprises a plate-shaped magnet body 35 and a plated layer (a layer of metal plating) 36 formed on the magnet body 35 by mean of metal plating. A thickness D of plated layer 36 is specifically arranged with a clear contrast to the prior art such as Japanese. Published Patent Application No. 6-140217. Plated layer 36 is not limited to a material of metal and a method of plating. A specific limitation is that plated layer 36 is made of a magnetic material having the predetermined thickness D.

Herein there is discussed a difference between plated layer 36 employed in the embodiment according to the present invention and a plated layer disclosed in Japanese Published Patent Application No. 6-140217. This prior art clearly describes that the plated layer, which has a thickness ranging from 3 to 20 μm, is plated on the surface of each rare-earth permanent magnet. That is, the maximum thickness of the plated layer in this prior art is 20 μm. In contrast, thickness D of plated layer 36 employed in the embodiment according to the present invention is 70 μm (D=70 μm) under a condition that the high-frequency flux of around 3 KHz is applied and employed metal in metal plating is nickel. 70 μm is a lower limit of thickness D of plated layer 36 in the embodiment according to the present invention, and a critical meaning of the lower limit value (D=70 μm) is explained as follows.

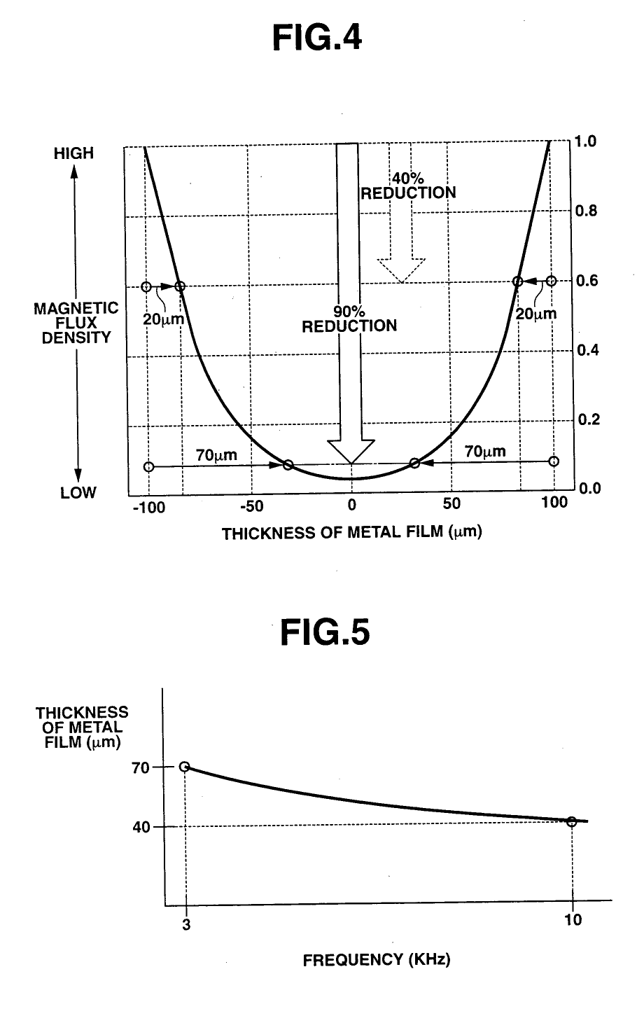

FIG. 4 is a characteristic graph for explaining a critical meaning of the lower limit (D=70 μm) of thickness D of plated layer 36 under the condition that the frequency of the high-frequency magnetic flux is 3 KHz. This characteristic graph was provided on the basis of Thomson's equation expressed by the following expression (1).

$$\frac{B}{Bs} = \sqrt{\frac{cosh [ 2 α x ] + cos [ 2 α x ]}{cosh [ ξ ] + cos [ ξ ]}} \qquad ( 1 )$$

where α is a permeability coefficient dependent on physical properties, ξ is a product of a thickness of magnetic member and α, x is a distance from a surface of the magnetic substrate, B is the magnetic flux density at position advanced by the distance x from the surface, and Bs is the magnetic flux density at the surface.

In the graph of FIG. 4 a vertical axis denotes a magnetic flux density under the condition that the frequency of the high-frequency flux is around 3 KHz. In the vertical axis, the magnetic flux density at a top end of the vertical axis is set at maximum and herein conveniently set at 1.0, and the magnetic flux density at a bottom end of the vertical axis is set at minimum and herein conveniently set at 0.0. A horizontal axis denotes a thickness of plated layer 36. In the horizontal axis, a point 0 denotes a center point of the plated layer 36 in the thickness direction, points ±50 denote points moved form the center point 0 toward outer and inner surfaces, respectively, by 50 μm, and points ±100 denote points moved form the center point 0 toward outer and inner surfaces, respectively, by 100 μm.

It is considered that induction heating of rare-earth permanent magnets 28 through 31 is suppressed to an ignorable level when 90% of the magnetic flux density reaching the magnet body 35 is cut. As is clearly shown in FIG. 5, 90% of the magnetic flux density is reduced at the point 70 μm advance from a surface of plated layer 36 toward the center point of plated layer 36. Accordingly, it is necessary that plated layer 36 has thickness D of at least 70 μm under the condition that the frequency of the high-frequency magnetic flux is 3 KHz and nickel is plated on magnet body 35.

On the other hand, when the thickness of the layer of metal plating ranges from 3 to 20 μm as described in the prior art, the ratio of the magnetic flux density ranges from about 1.0 to about 0.6 as shown in FIG. 4. That is, the reduction rate of the magnetic flux density by the plated layer of the prior art is limited to about 40%. Accordingly, in case of the prior art, it is difficult to prevent the induction heating of the permanent magnets of the rotor since the magnet bodies are exploded in the high-lever magnetic flux density which is, for example, 50% higher than that of the present invention.

With the rotating machine of the embodiment according to the present invention, thickness D of plated layer 36 of covering the whole surface of each magnet body 35 is properly set by taking account of the material of metal plating (actually an electrical conductivity and the permeability of the material), the frequency of the high-frequency magnetic flux and a desired suppression level of the magnetic flux density (rate of the remaining magnetic flux). For example, thickness D of plated layer 36 is set at 70 μm (D=70 μm) under a condition that the frequency of the high-frequency flux acting on permanent magnets 28 through 31 including plated layer 36 is around 3 KHz and kind of metal for metal plating is nickel. Accordingly, it becomes possible to decrease the energy of the high-frequency magnetic flux reaching the magnet body 35 to a desired suppression level (about 90% reduction). As a result, the induction heating is suppressed, and therefore there are solved various problems such as the output lowering of the motor in a reversible demagnetization range according to temperature and a losing of the magnetic properties in an irreversible demagnetization range according to temperature.

Although the embodiment according to the present invention has been shown and described such that an appropriate thickness D of plated layer 36 is 70 μm, this thickness is an example. More specifically, it is necessary to determine the appropriate thickness D of plated layer 36 taking account of the material of metal plating (actually an electrical conductivity and the permeability of the material), the frequency of the high-frequency magnetic flux and a desired suppression level of the magnetic flux density (rate of the remaining magnetic flux), as discussed above.

FIG. 5 shows a relationship between the appropriate thickness D of plated layer 36 and the frequency of the high-frequency magnetic flux when nickel is used as a material of the metal plating and the reduction effect of the magnetic flux density is 90%. In FIG. 5, a vertical axis denotes a thickness of plated layer 36, and a horizontal axis is the frequency of the high-frequency magnetic flux. As is apparent from FIG. 5, the appropriate thickness D of plated layer 36 decreases as the frequency of the high-frequency magnetic flux increases. More specifically, when the appropriate thickness D under the frequency of 3 KHz is 70 μm, the appropriate thickness D under 10 KHz becomes 40 μm. This is due to a skin effect in the technical field of electromagnetic shielding and represents that a portion in plated layer 36, at which eddy current causes, becomes shallower as the frequency of the high-frequency magnetic flux becomes higher.

When other material except for nickel is used as a material of plated layer 36 and/or when the frequency of the high-frequency magnetic flux is changed between 3 and 10 KHz, the thickness under such a changed condition is obtained by multiplying a square root of a product of the electrical conductivity of the selected material, the magnetic permeability of the selected material and the frequency to a reference thickness D_{R}, which is a thickness under the condition that the selected material is nickel and the frequency is 3 KHz, or 40 μm which is a thickness under a condition that nickel is used as a material of metal plating and the frequency f of the high-frequency magnetic flux density is 10 KHz. That is, the thickness D of plated layer 36 made by the selected material is obtained by the expression (2).
D=D_{R}\sqrt{μσf}/\sqrt{μ_{R}σ_{R}f_{R}} (2)
where D_{R} is the reference thickness, μ is an electrical conductivity of the selected material, σ is an electromagnetic permeability of the selected material, f is the frequency of the high-frequency magnetic flux applied to plated layer 36, μ_{R} is an electrical conductivity of a reference material, σ_{R} is an electromagnetic permeability of the reference material, and f_{R} is the frequency of the high-frequency magnetic flux applied to plated layer 36 of the reference material. That is, the high-frequency magnetic flux is a magnet flux acting from stator 2 on rotor 3 (permanent magnets 28 through 31).

Although the suppression effect of induction heating is increased by increasing the thickness D of plated layer 36, excessive thickness of plated layer 36 will form a magnetic circuit of establishing a short circuit of the magnetic flux of the magnet so as to degrade a utility efficiency of the magnetic flux. Therefore, an upper limit of thickness D of plated layer 36 should be set, for example, at twice the lower limit as a target upper limit.

Although the embodiment according to the present invention has been shown and described such that the whole surface of magnet body 35 is covered with plated layer 36 of metal plating as shown in FIG. 3A, the invention is not limited to this and may be arranged such that only faces except for one surface 35a of magnet body 35 are covered with plated layer 36 as shown in FIG. 3B. That is, only the surfaces of magnet body 35 facing the rotor 2 may be covered with plated layer 36. When the limited surfaces of magnet body 35 are covered with plated layer 36, it is preferable that extending portions 36a and 36b having a proper length are formed at free ends of plated layer 36 as shown in FIG. 3B. This provision of extending portions 36a and 36b prevents reaction-function eddy current from concentrating at the free ends of plated layer 36, and thereby preventing a local heating of magnet body 35.

While the embodiment according to the present invention has been explained such that the desired suppression level of the magnetic flux density to be gained by plated layer 36 is 90%, the invention is not limited to this. Since the degree of the induction heating is varied according to the property of the employed rare-earth permanent magnet, the desired suppression level may be properly varied at a value adapted to the properties of the employed rare-earth permanent magnet. Further, since the degree of the induction heating is also varied according to the temperature of the employed rare-earth permanent magnet, the desired suppression level may be varied according to the operating temperature. More specifically, the desired suppression level may be switched to a high-temperature mode level and a low-temperature mode level. Furthermore, the desired suppression level may be properly varied according to the cooling effect of the rare-earth permanent magnet.

Although the embodiment according to the present invention has been described by specifying the details thereof and being expressly specified using the specific characters or values for the purpose of clarifying the concept of the invention, it is understood that the invention is not limited to these descriptions.

While there are omitted the detailed explanations as to the known matters, such as known method, known procedure, known architecture and known circuit structure, such omission has been made for the purpose of simplifying the explanations and has never been made intentionally. Further, the known matters are obvious to those skilled in the art at the time of filing a patent application of the present invention and are obviously included in the descriptions.

This application is based on a prior Japanese Patent Application No. 2004-12268. The entire contents of the Japanese Patent Application No. 2004-12268 with a filing date of Jan. 20, 2004 are hereby incorporated by reference. The scope of the invention is defined with reference to the following claims.

1. A rotating machine comprising:
a rotor in which a permanent magnet is embedded; and
a stator disposed around the rotor;
wherein a surface of the permanent magnet, which faces the stator, is covered with a magnetic material, and a thickness of the magnetic material is determined on the basis of an electrical conductivity of the magnetic material, a magnetic permeability of the magnetic material and a frequency of a high-frequency magnetic flux acting from the stator on the rotor.

2. The rotating machine as claimed in claim 1, wherein the thickness of the magnetic material is a square root of the product of an electrical conductivity of the magnetic material, a magnetic permeability of the magnetic material and a frequency of a high-frequency magnetic flux directing from the stator to the rotor.

3. The rotating machine as claimed in claim 1, wherein the magnetic material essentially consists of nickel.

4. The rotating machine as claimed in claim 2, wherein the frequency of the high-frequency magnetic flux is greater than 3 KHz and smaller than 10 KHz, and the thickness of the magnetic material is greater than or equal to 40 μm and smaller than or equal to 70 μm.

5. The rotating machine as claimed in claim 1, wherein the permanent magnet is a rare earth permanent magnet.

6. The rotating machine as claimed in claim 1, wherein the permanent magnet is made from a sintered body of one of Sm—Co alloy and Nd—Fe—B alloy.

7. The rotating machine as claimed in claim 1, wherein the permanent magnet covers all surfaces of the permanent magnet.

8. A permanent magnet synchronous machine comprising:
a stator comprising a cylindrical yoke and teeth around which stator windings are wound, respectively;
a rotor disposed in a center space defined by the stator to be coaxial with the stator and rotatable with respect to the stator, the rotor comprising a plurality of permanent magnets which are disposed around a center axis of the rotor; and
a metal layer covering at least a surface of each permanent magnet which faces the stator, the metal layer being made of a magnetic material, a thickness of the magnetic material being determined on the basis of an electrical conductivity of the magnetic material, a magnetic permeability of the magnetic material and a frequency of a high-frequency magnetic flux acting on the rotor.
